(19) United States
(12) Patent Application Publication
(10) Pub. No.: US 2017/0167886 A1
(43) Pub. Date: Jun. 15, 2017

(54) Interacting with a User Using a Dynamic Map

(71) Applicant: Viacom International Inc., New York, NY (US)

(72) Inventors: Brandon LUCAS, WASHINGTON, DC (US); Martez MOORE, WASHINGTON, DC (US); Rick GRIMES, WASHINGTON, DC (US); Eric WATSON, WASHINGTON, DC (US)

(21) Appl. No.: 15/431,366

(22) Filed: Feb. 13, 2017

Related U.S. Application Data
(63) Continuation of application No. 13/432,809, filed on Mar. 28, 2012, now abandoned.

(51) Int. Cl. G01C 21/36; G01C 21/34; G06Q 30/02

(52) U.S. Cl. CPC G01C 21/3679; G06Q 30/0266; G01C 21/3697; G01C 21/3484; G01C 21/3602; G01C 21/3614; G01C 21/3617; G01C 21/3641; G06Q 30/0255; G06Q 30/0257; G06Q 30/0263

(57) ABSTRACT

Described herein is technology for, on a computer, facilitating interaction with a user utilizing a dynamic map displayed on a display device. A computer receives a use indication that the user has recently used an application on a computing device associated with the user, e.g., a mobile device, with the use indication including the location of the user. Then, a graphic is displayed on the dynamic map representing the user's location. The computer then receives a selection indication that the graphic has been selected, e.g., a person chooses a particular graphic to interact with. Then, based on the selection indication, the computer initiates an interaction with the user.

### PRIORITY CLAIM

The present application is a Continuation Application of pending U.S. Non-Provisional patent application Ser. No. 13/432,809 filed on Mar. 28, 2012. The entire disclosure of this prior application is considered as being part of the disclosure of the accompanying application and hereby expressly incorporated by reference herein.

### FIELD OF THE INVENTION

The present invention relates generally to interacting with viewers of a television show and, more specifically, utilizing a dynamic map that is based on viewer activity to select a participant to interact with.

### BACKGROUND

On television game shows, a participant is typically in the television studio and answers questions or performs a physical act in order to win a prize. In some cases, the prize is based in part on the participant's performance. In some game or award shows, viewers of the program can cast votes for a particular outcome using their telephones, or more recently, text messages and the Internet. These interactions typically occur asynchronously with the broadcast of the show. In still other shows, users can call in and try to be a particular number caller, e.g., “be the 10^{th} caller” where only that numbered caller is awarded a prize.

### SUMMARY OF THE INVENTION

The present invention provides technology, e.g., a method executed on one or more computers, a system, an apparatus, and a computer program product, tangibly embodied on a non-transitory computer-readable storage medium for facilitating interaction with a user by utilizing a dynamic map. For purposes of this document, “users” and “viewers” are used interchangeably; it is presumed that a user is watching the television show and is therefore a viewer, although the scope of the invention does not require the user to actually be watching the television show.

In one aspect, there is a method, executed on a computer, for facilitating interaction with a user utilizing a dynamic map displayed on a display device. There is also a computer program product, tangibly embodied in a non-transitory computer-readable storage medium, e.g., RAM, on a hard disk, on a DVD, etc., for facilitating interaction with a user utilizing a dynamic map displayed on a display device. In either case, the computer receives a use indication that the user has recently used an application on a computing device associated with the user, e.g., a mobile device, with the use indication including the location of the user. Then, a graphic is displayed on the dynamic map representing the user—by way of instructions sent to the display—where the placement of the graphic on the dynamic map is based on the user's location. Then the computer receives a selection indication that the graphic has been selected, e.g., a person chooses a particular graphic to interact with. Then, based on the selection indication, the computer initiates an interaction with the user.

In another aspect, there is another method, executed on a computer, for facilitating interaction with a user utilizing a dynamic map displayed on a display device. There is also a computer program product, tangibly embodied in a non-transitory computer-readable storage medium, for facilitating interaction with a user utilizing a dynamic map displayed on a display device. Similar to the above, these involve receiving a use indication that the user has recently used an application on a computing device associated with the user, the use indication including the user's location. Then a graphic is displayed on the dynamic map representing the user, where the placement of the graphic on the dynamic map is based on the user's location. In this aspect, the user is preselected for interaction. Then indication that a graphic has been selected is received and the dynamic map is updated to reflect the information of the user regardless of which graphic was actually selected. Finally, an interaction with the user is initiated.

In another aspect, there is a system configured to provide functionality equivalent to either of the above aspects. The system includes an app or program that runs on a device that transmits location information for the user using the device to a user server. The user server is in communication with a display server, which in turn displays a dynamic map on a display. The user server provides information for each user to the display server and the display server displays a graphic on the display for each user that is using the app. A user is selected from the users displayed on the map, either via selection via the display or the user is pre-selected, and the system is used to initiates interaction with the user. In some embodiments the display server is used to initiate interaction with the user and in other embodiments the user server does. And in some embodiments the user server and the display server can be combined physically into one machine with different software modules or hardware or a combination of both performing the respective functions of each server.

All of the above aspects enjoy several benefits. For example, in some embodiments, initiating an interaction with the user involves calling the user. The call can be made using a telephone connection, a VoIP connection, a video chat connection, or a any combination of these. Additionally or alternatively, initiating an interaction with the user can involve awarding the user a prize. And in some embodiments, not only is the user's graphic displayed on the display, but the computer also receives a number of indications that a respective number of users have recently used the application on a respective number of computing devices. Each of these computing devices is in turn each associated with a respective user. And each indication has the location of that respective user. Then, a graphic is displayed on the dynamic map for each user, where the placement of each graphic on the dynamic map is based on the location of the respective user.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a system diagram showing the various components used in the invention;

FIG. 2A depicts an exemplary interface to the app that is displayed on the user's mobile device;

FIG. 2B depicts a prompt presented to the user to allow the app access to the user's geographic location;

FIGS. 3A and 3B depict the user being shown on a map approximately where they are using the app, based on the user's geographic location.

FIG. 4 depicts a zoomed-into portion of the map;

FIG. 5A depicts a prompt asking the user to register;

FIG. 5B depicts a page where the user enters his or her registration information;

FIG. 5C depicts a prompt confirming the submission of the user's registration;

FIG. 6 depicts a map shown on television during the show, which is generated by the display server and displayed on the display; and

FIG. 7 shows a method for facilitating interaction with a user utilizing a dynamic map displayed on a display device

### DETAILED DESCRIPTION

At any given time slot, there are literally hundreds of television shows competing for a viewer's attention. Additionally, many technology savvy viewers expect shows that they spend time viewing to provide a more engaging experience than simple one-way display-on-a-television entertainment. Indeed, many television shows now incorporate user's feedback (provided via Twitter or Facebook) near real-time as part of the broadcast. The present invention provides a more engaging viewer experience by way of integrating technology both in an app on the viewer's mobile device, tablet, or computer as well as in the studio that allows the host or hosts of the show to interact with the viewers

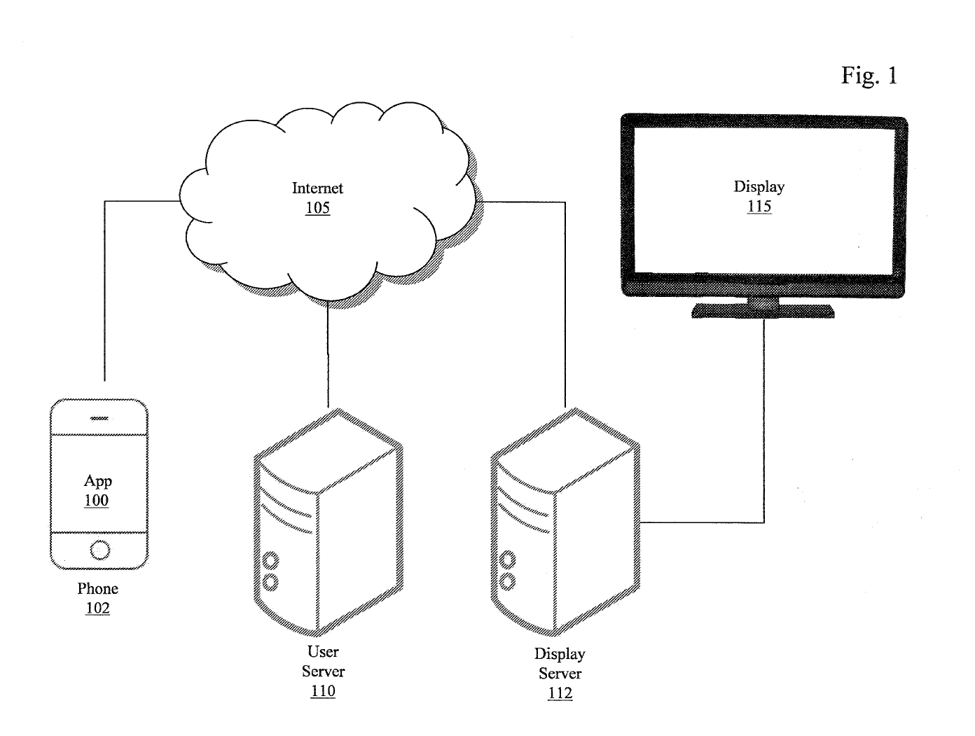

FIG. 1 is a system diagram showing the various components used in the invention. In FIG. 1, there is an application (“app”) 100 that is used on the viewer's mobile device 102, e.g., a cellular phone, tablet, or computer. The “app” does not have to be on an application on mobile device—it could be a web page or a flash widget within a web page or an executable program on a desktop or laptop computer. Further description of the app 100 will focus on the scenario where it is installed on the user's mobile device 102, but the invention is expressly not limited to those embodiments. Typical examples of mobile devices 102 are the IPOD TOUCH® by Apple, or phones, e.g., Apple's IPHONE® that runs iOS and the HTC INCREDIBLE® that runs the Android operating system provided by Google. Other mobile devices and tablets are within the scope of the invention. Examples of tablets are Apple's IPAD® that runs iOS and HP's TOUCHPAD™ which runs webOS provided by Palm. An example of a computer is Dell's XPS line of personal computers (PCs). It is also understood that while the description herein is of one app, one server and one display, there may be multiple apps communicating with one server, or with multiple serves, that are in turn communicating with one display or multiple displays. A typical use case is many mobile devices 102, each representing a different viewer/user, are in communication with one server 105 (or multiple servers acting as one server, e.g., a server “farm”), that is in communication with one display. But the invention is not so limited.

The app 100 communicates, via the Internet 105, cellular phone connection (not depicted), WiFi, or some combination of these, to the user server 110. The user server 110 receives information from the app 100 (or mobile device 102, or a combination of these) such as the user's name, location, birthday, phone number, or some combination of these and other information. The user server 110 stores information about the user, e.g., that the user is available to receive a call, the user's name, phone number and age. In some embodiments the information is stored in a database. In other embodiments it is stored in a file, e.g., XML or a flat file. In other embodiments it may be stored on a hard drive such as in a network attached storage (“NAS”) or stored in a storage area network (“SAN”). Other storage technologies are contemplated and the invention is not limited to any one particular storage mechanism or medium. The user server 100 also communicates with a display server 112, via either the internet, a wired, or a wireless connection, and shares the user's location, name, phone number and age with the display server 112. The display server 112 also stores the user's information and can use a storage mechanism similar to or different from the storage mechanism of the user server 110, e.g., a database, a file, a NAS, a SAN, etc. to store the user's information. The display server 112 provides an application that generates a map (including a graphic representing the user) using the information passed to it. The server display 112 is in signal communication, e.g., over an HDMI, component, VGA, S-video, or RF. Connection, etc with a display 115. The display 115, as further described below, typically displays the map and user location generated by the display server 112. In the case of multiple users being in communication with the user sever 110, the map generated by the display server 112 includes graphics for some or all of the users that are communicating with the user server 110. It should also be understood that although the user server 110 and display server 112 are described as separate servers, their functionality can be combined and run on one server or load balanced across multiple servers.

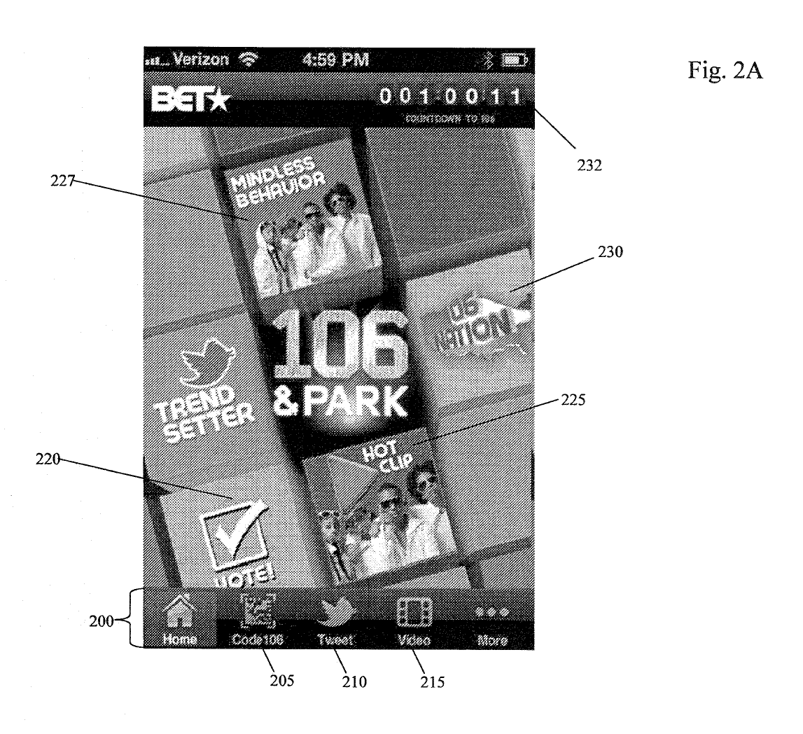

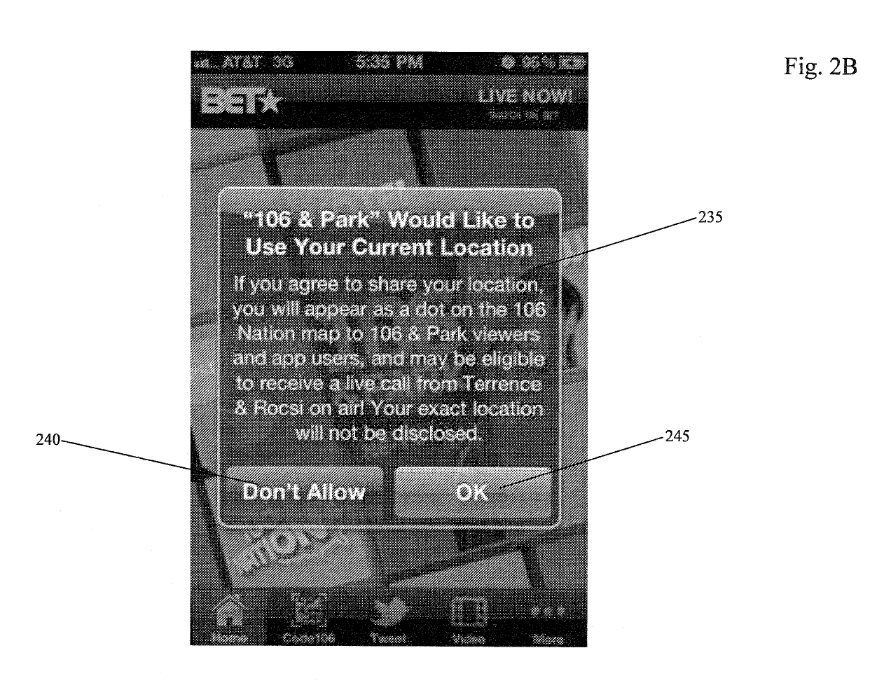

FIG. 2A depicts an exemplary interface to the app 100 that is displayed on the user's mobile device 102. The app 100 has a navigation bar 200 which allows the user to access various functionality provided by the app, e.g., functionality to read QR codes 205, send tweets 210 via Twitter, and watch videos 215, by way of touching or selecting the area on the app's display that corresponds to the desired functionality. This input can be finger input, pen input, mouse input, keyboard input, or the like. The app 100 also has functionality that allows the user to vote 220, access “hot clips” (videos) 225, specific artist information or interviews 227 (in this case the group “Mindless Behavior”), or launch the map interaction functionality 230. When the show is not airing, in some embodiments there is a countdown 232 that shows the approximate time between the current time (according to the device's 102 internal clock and the estimated air time for the show for a particular time zone, e.g., Eastern time.

Upon first opening or executing the app, the user is prompted 235 to allow the app 100 access to the user's geographic location (as shown in FIG. 2B). The user is instructed that the location information will be shared, that their location will be displayed to other viewers, and that they may receive a call from the show's hosts, in this case Terrence and Rosci. The user may disallow 240 sharing the geographic location information or allow 245 it. If the user allows 245 it, the user's location (and other information described below) is automatically transmitted to the user server 110). The geographic location functionality can be provided by the app 100 or by an application programming interface (API) provided by the mobile device's 102 operating system.

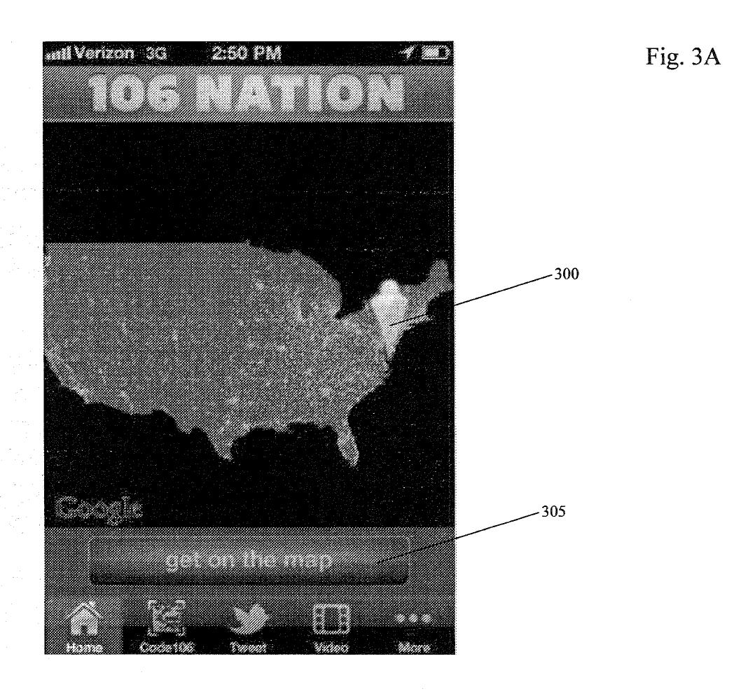

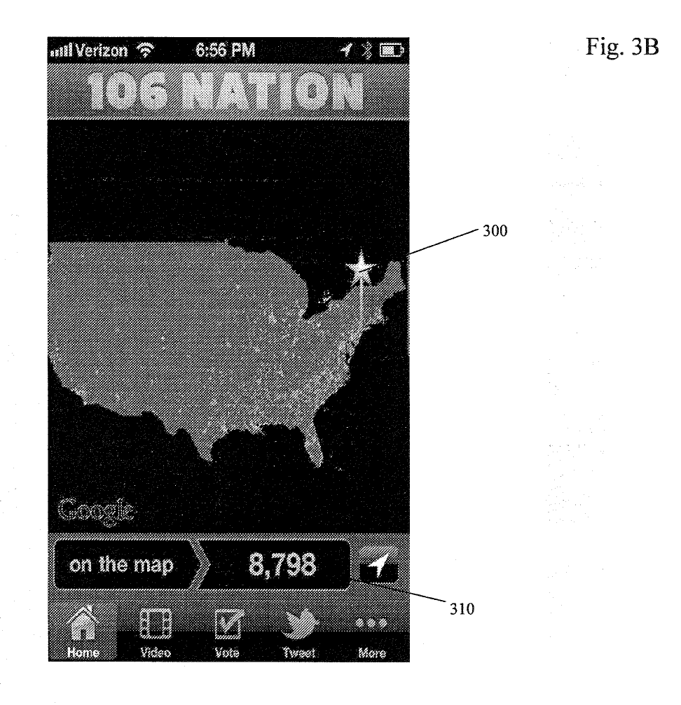

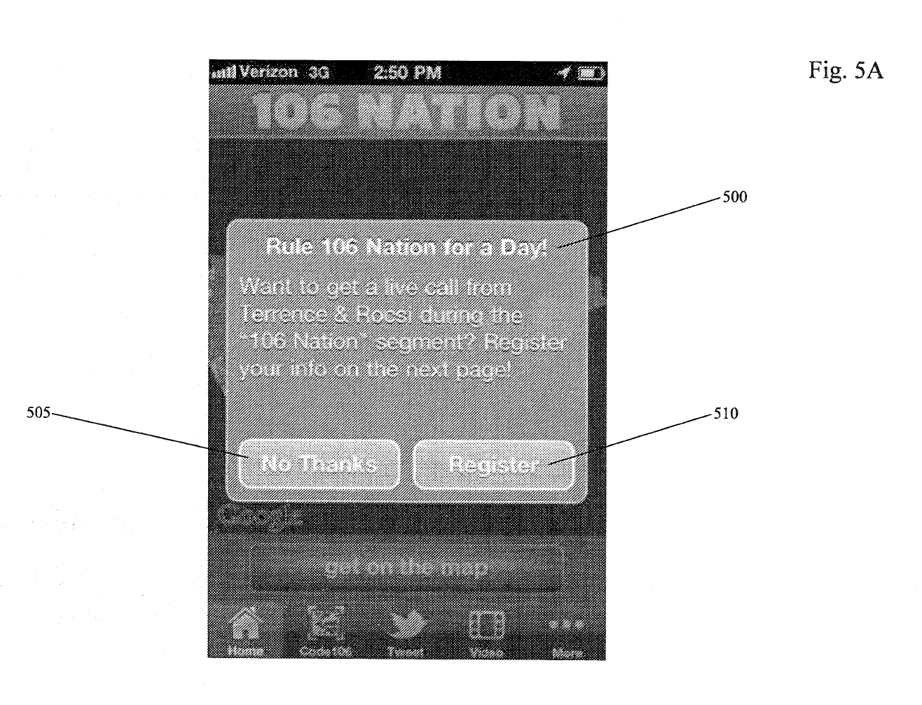

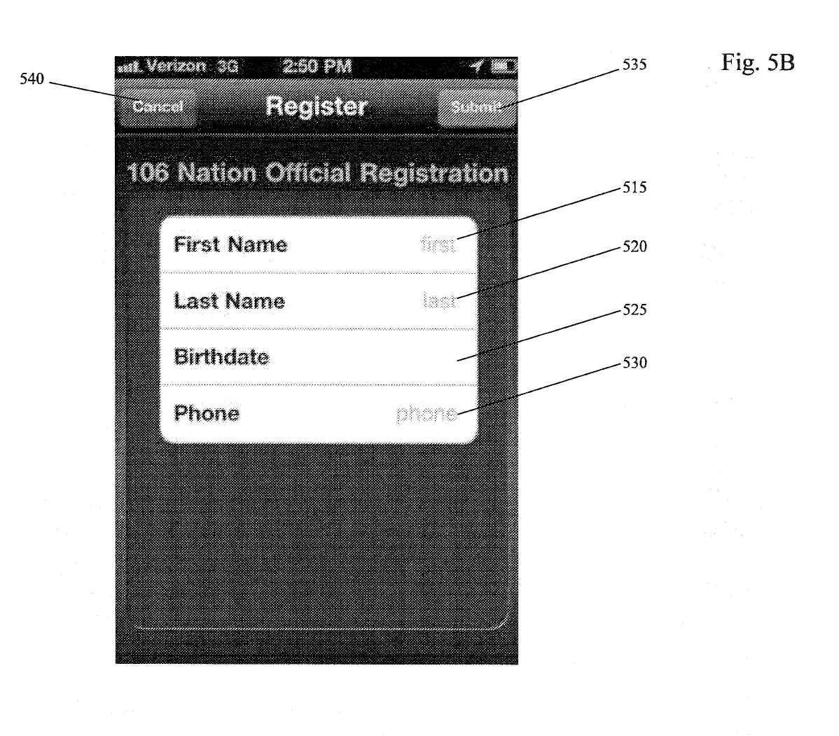

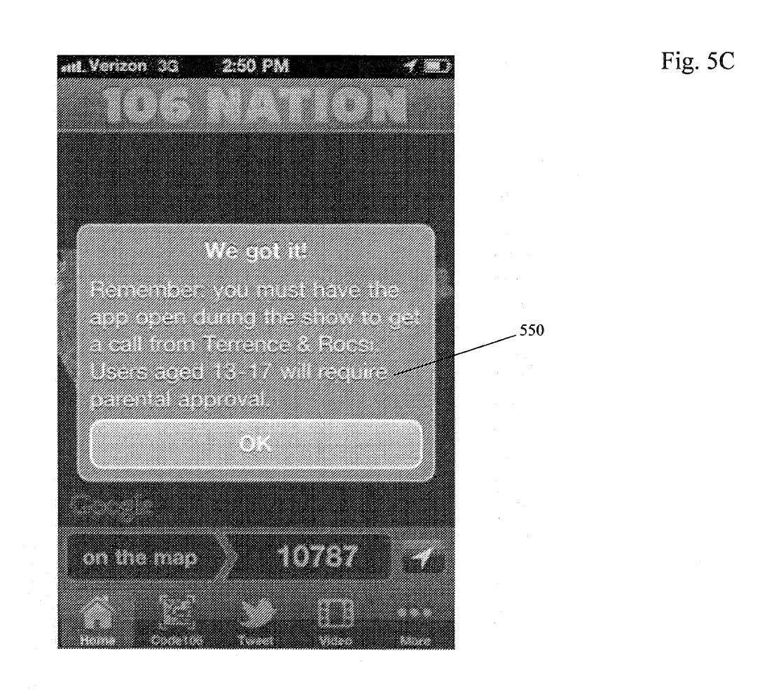

When the user launches the map interaction functionality 330 for the first time, the user is then shown a screen similar to that shown in FIG. 3A. In FIG. 3A, the user is shown on a map (using a graphic 300) approximately where they are located, which is based on the geographic location information of the device the user is using. Beneficially, the map in FIG. 3A also shows the approximate location of all other app users who have the app open and have allowed the app to access their geographic location. The user is also prompted 305 to “get on the map.” If the user activates the “get on the map” functionality and registers to interact with the live show (described below with respect to FIG. 5A), the user's location information is thereafter sent to the server 105 via the communications mediums described above every time the user launches the app. If the user has already registered, they instead see a map as shown in FIG. 3B where instead of “get on the map” they are shown a tally 310 of the number of users on the map. The user is still shown 300 their approximate location using a graphic 300. The graphic can be a star with a line to the user's location (shown in FIG. 3B), an icon similar to a person (as shown in FIG. 3A) or some other graphic.

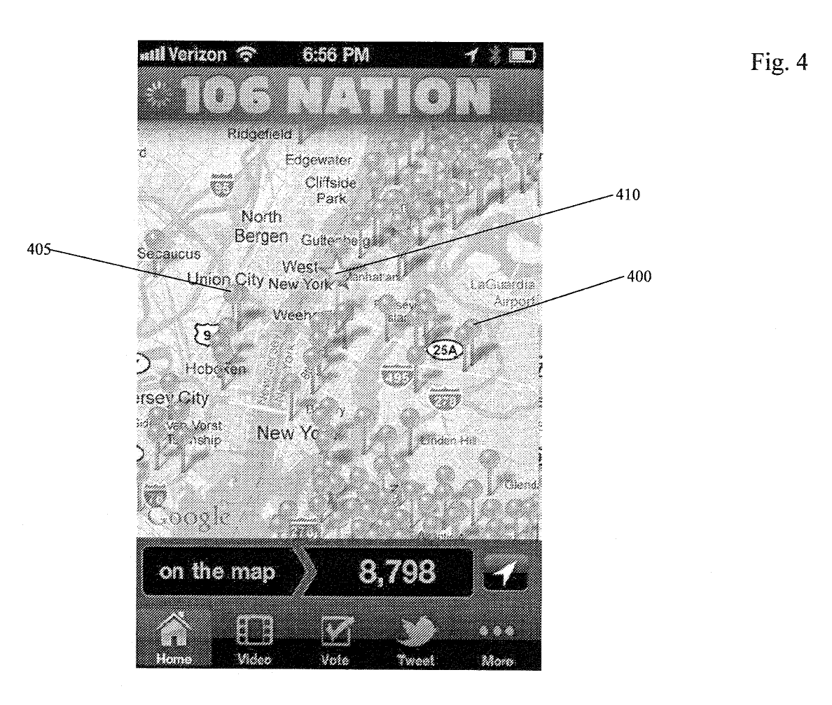

In either pre-registration or post-registration scenario, the server 105 beneficially also sends updated location information for other users back to the app 100 and the app 100 updates its version of the map so that the current user can see the locations of other users that are logged in, represented by color variations on the map. The user is then able to zoom into the map in the app 100 using standard navigation techniques, e.g., pinching and pulling with their fingers on the display. If the user zooms into a particular area (as shown in FIG. 4) of the map, the user is shown the location of users that are also using the app on their respective devices, e.g., as indicated by round pins 400 and 405. The user's location is represented among the other users 400, 405 by a different graphic 410, e.g., a star on a pole.

Referring to FIG. 5A, in some embodiments, if this is the first time the user has launched the app 100, the user is prompted 500 to register their personal information to potentially get a call from the show's host or hosts during the broadcast. The user can decline 505 or register 510. If the user declines 505, they will not be eligible to receive the call or other interactions with the show until they do register. If the user opts to register 510, they are taken to a screen similar to that shown in FIG. 5B. On the screen depicted in FIG. SB, the user is prompted to provide his or her first name 515, last name 520, birthdate 525, and phone number 530. The information can be represented using various data formats, e.g., the first and last names 515, 520 can be varchars, the location can be GPS coordinates (e.g., latitude and longitude) represented by doubles and the phone number 530 can be a bigint. The invention is not limited to these, they are merely given as examples. The information is stored in the app for future use and is submitted 535 to the user server 110 and also stored there. In some embodiments, the information is only stored in the user server 110 for the user's session, e.g., as long as the user continues to interact with the app or for a fixed amount of time such as thirty minutes. In some embodiments, the user's information is stored permanently on the user server 110. The user's information is also sent to the display server 112, either by the user server 110 or by the app 100 directly. The user server 110 and/or the display server 112 may also store a flag which indicates if the user is available or logged in; this can be a Boolean value. Additionally, the user server 110 and/or the display server 112 can determine, based on the location information, the nearest town to the user and can store this information as a string or varchar for later retrieval and/or display. The app 100, user server 110, and/or display server 112 can also be configured to periodically update the user's information, e.g., each time the user logs in or upon a change in the user's location, e.g., if the user's latitude or longitude changes by 0.015 or more. Beneficially, in some embodiments, when a user has been inactive for a period of time, e.g., 30 minutes, the user's record is purged from the user server's 110 database. When a user logs in again or opens the app 100, the user's information is sent by the app 100 to the user server 110 again.

The user may also opt to cancel the registration process by selecting the cancel button 540. If the user's information is successfully submitted to the user server 110, the user is prompted 550 with a screen similar to that depicted in FIG. 5C.

In some embodiments, the user's age is calculated based on the birthdate provided, either by the app 100 or by the user server 110 or both. If the user is under 13 years old, the application will not send the information to the user server 110 or will prevent the user from registering entirely. If the user is 13 to 17 years old, the application will notify the user that their parent's permission will be required before their voice can be transmitted on the show. In some embodiments, if the user is 13 to 17 years old, the app 100 will still send the information to the user server 110 but the user server 110 will not send that information to the display server 112. In other embodiment, the user's information is still sent to the display server 112 but the map generated by the display server 112 does not include graphics for users that are 13 to 17 years old.

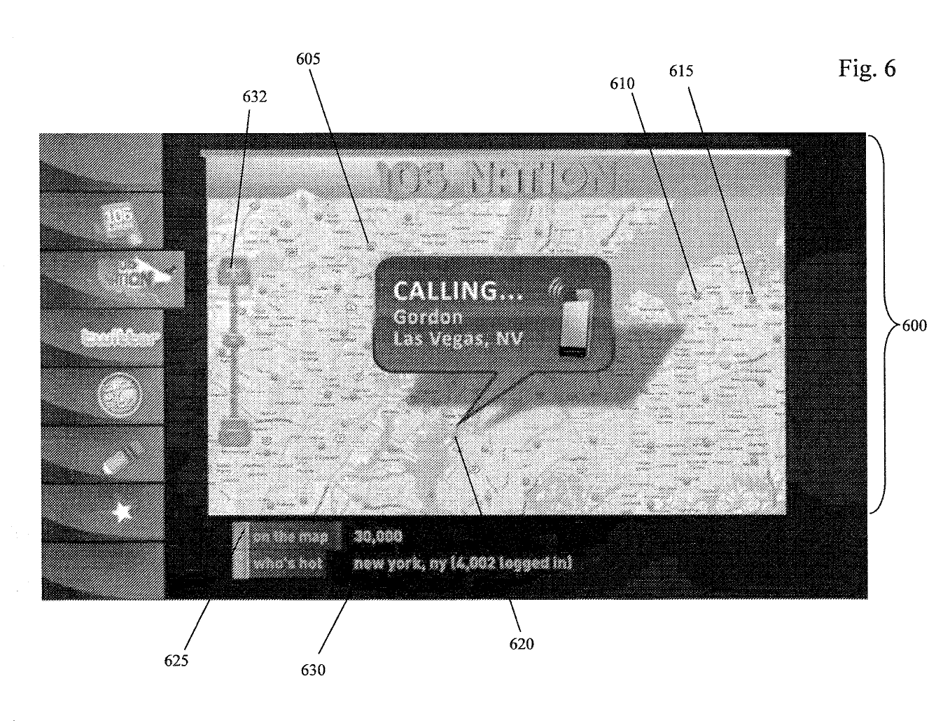

During the show, a map 600 similar to that shown in FIG. 6 is generated by the display server 112 and displayed on the display 115. As users launch the app 100 on their respective mobile devices 102, the app 100 sends the user's information to the user server 110, which then sends the information to the display server 112 as described above, and the display server 112 updates its representation of who is logged in and active. Graphics, e.g., 605, 610, 615, and 620, show users that have the app 100 open on their mobile device 102 at the time of broadcast. Also typically on the screen are statistics such as how many users total are on the map 625 (in this case 30,000) and what areas are “hot” 630, i.e., has a large number of logged in users, in this case New York, N.Y., with 4002 users logged in. The map 600 can be manipulated to provide additional information, e.g., it can be moved around, zoomed into and zoomed out of using, e.g., using zoom controls 632.

By selecting a particular user's graphic 620 via interacting with the display 115 (if the display is a touchscreen) or the display server 112 (via mouse, keyboard, etc.), the host or hosts of the show can then interact with the user. In some embodiments, selecting a user's graphic 620 causes the display server 112 to display additional information about the user, e.g., the user's name and location. In some embodiments, selecting the user's graphic causes the display server 112 to call the user via, e.g., a telephone connection, a voice over Internet Protocol (“VoIP”) connection, or video chat connection, e.g., Skype, or a combination of these. In some embodiments, selecting a user's graphic 620 results in the user being awarded a prize.

In some embodiments, selection of a particular user on the map is only simulated. Specifically, the display server 112 populates the graphics on the map based on app users' approximate locations as described above, but prior to the host selecting a particular user on the map, only a pre-selected group of users are made available for interaction, e.g., only a select pool of users from a selected city are allowed to be selected. Then, from this small pool, a single user is selected by the tv show's production crew, e.g., a producer. This pre-selection process allows show's production crew to screen users and to ensure that only quality users will be appearing on air. Thus, before the host selects a graphic that represents a user, the crew member has selected a particular user to put on the air and once the crew member has called the user and decided that they do in fact want to put this user on the air, the crew member activates functionality, e.g., clicks a button, to have that user's information passed through to the display server 112, which will then display it on the screen 115. In this embodiment, when the host selects any user graphic on the screen, only the pre-selected user's name and city pop up on screen, regardless which user's graphic is selected.

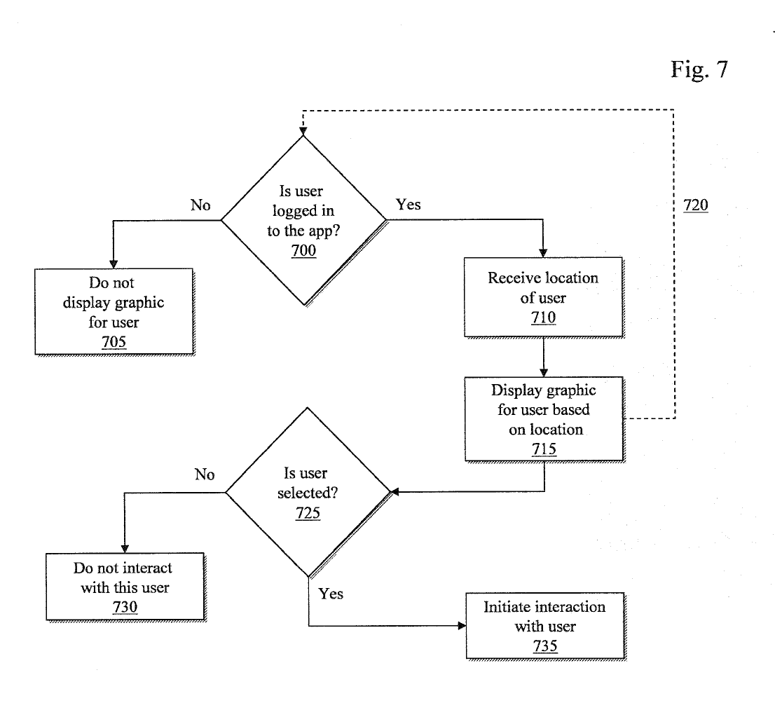

FIG. 7 shows a method for facilitating interaction with a user utilizing a dynamic map displayed on a display device. First, it is determined 700 if the user has his/her app open. If the user does not have his/her app open, no action is necessary for that user (because that user's information is not currently stored in the user server 110 or the display server 112) and a graphic is not displayed 705 for the user. If the user has the app open, the user's location is received 710 and a graphic is displayed 715 on the dynamic map based on the user's location. This process is repeated (720, shown in phantom) for each user until it is time to select a user. When it is time to select a user, e.g., during the show, it is determined 725 which user is selected. If a particular user is not selected 730, no interaction is initiated with that user. If a particular user is selected 735, interaction with that user is initiated, e.g., that user is called. As described above, in some embodiments, the interaction is only simulated.

The above-described techniques can be implemented in digital electronic circuitry, or in computer hardware, firmware, software, or in combinations of them. The implementation can be as a computer program product, i.e., a computer program tangibly embodied in an information carrier, e.g., in a non-transitory computer-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser or a dynamic map through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1-16. (canceled)

17. A method, executed on a computer, for facilitating an interaction between a first user and a media program utilizing a dynamic map displayed on a display device, the method comprising:
receiving, by the computer, a first use indication each time the first user logs into an application on a computing device associated with the first user, the first use indication comprising a location of the first user;
sending instructions after receipt of the first use indication, by the computer to the display device, to display a first graphic on the dynamic map representing the first user, whereby a placement of the graphic on the dynamic map is based on the location of the first user;
receiving, by the computer from the display device, a selection indication that the first graphic has been selected by the media program; and
initiating, by the computer, the interaction between the first user and the media based on the selection indication.

18. The method of claim 17, wherein initiating the interaction between the first user and the media program comprises the media program calling the first user using one of a telephone connection, a VoIP connection, a video chat connection, and a combination thereof.

19. The method of claim 17, wherein initiating the interaction between the first user and the media program comprises awarding the first user a prize from the media program.

20. The method of claim 17, further comprising, before receiving the selection indication:
receiving, by the computer, a second use indication each time a second user logs into the app via a further computing device, the second use indication comprising a second location of the second user;
sending instructions after receipt of the second use indication, by the computer to the display device, to display the first graphic and a second graphics graphic on the dynamic map, the second graphic representing the second user, whereby a placement of the second graphic on the dynamic map is based on the second location of the second user.

21. The method of claim 20, wherein the media program is a broadcast program and wherein the computer determines locations of the first and second users at a time of broadcast of the media program.

22. A method, executed on a computer, for facilitating an interaction between a first user and a media program utilizing a dynamic map displayed on a display device, the method comprising:
receiving, by the computer, a first use indication each time the first user logs into an application on a computing device associated with the first user, the first use indication comprising a first location of the first user;
sending instructions after receipt of the first use indication, by the computer to the display device, to display a first graphic on the dynamic map representing the first user, whereby a placement of the first graphic on the dynamic map is based on the location of the first user, the dynamic map including a plurality of further graphics representing respective further users, further placements for each of the further graphics being based on respective locations of the further users;
preselecting the first user for the interaction with the media program;
receiving, by the computer from the display device, an indication that one of the first graphic and one of the further graphics has been selected;
updating the dynamic map to reflect information of the first user when one of the further graphics is selected; and
initiating, by the computer, the interaction between the first user and the media program.

23. The method of claim 22, wherein initiating the interaction with the first user comprises calling the user using one of a telephone connection, a VoIP connection, a video chat connection, and a combination thereof.

24. The method of claim 22, wherein initiating the interaction between the first user and the media program comprises awarding the first user a prize from the media program.

25. The method of claim 22, further comprising, before receiving the selection indication:
receiving, by the computer, a further use indication each time a further user logs into the application on further, respective computing devices, the further use indications comprising the respective locations of the further users;
sending instructions, by the computer to the display device, to display the first graphic and the further graphics on the dynamic map.

26. A computer program product, tangibly embodied in a non-transitory computer-readable storage medium, for facilitating an interaction between a first user and a media program utilizing a dynamic map displayed on a display device, the computer program product comprising instructions operable to cause a computer to:
receive a first use indication each time the first user logs into an application on a computing device associated with the first user, the first use indication comprising a location of the first user;
display a first graphic on the dynamic map representing the first user, whereby a placement of the first graphic on the dynamic map is based on the location of the first user;
receive a selection indication that the first graphic has been selected by the media program; and
initiate the interaction between the first user and the media program based on the selection indication.

27. The computer program product of claim 26, wherein initiating the interaction with the first user comprises calling the first user using one of a telephone connection, a VoIP connection, a video chat connection, and a combination thereof.

28. The computer program product of claim 26, wherein initiating the interaction between the first user and the media program comprises awarding the first user a prize from the media program.

29. The computer program product of claim 26, further comprising instructions operable to cause the computer to:
receive a further use indication each time a further user logs into the application on a further computing device, the further use indication comprising a further location of the further user;
display the first graphic and a further graphic on the dynamic map, the further graphic representing the further user, whereby a further placement of the further graphic on the dynamic map is based on the further location of the further user.

30. A computer program product, tangibly embodied in a non-transitory computer-readable storage medium, for facilitating interaction with between a first user and a media program utilizing a dynamic map displayed on a display device, the computer program product comprising instructions operable to cause a computer to:
receive a first use indication each time the first user logs into an application on a computing device associated with the first user, the first use indication comprising a location of the first user;
display a first graphic on the dynamic map representing the first user, whereby a placement of the first graphic on the dynamic map is based on the location of the first user, the dynamic map including a plurality of further graphics representing respective further users, further placements for each of the further graphics being based on respective locations of the further users;
preselect the first user for the interaction with the media program;
receive an indication that one of the first graphic and one of the further graphics has been selected;
update the dynamic map to reflect information of the first user when one of the further graphics is selected; and
initiate the interaction between the first user and the media program.

31. The computer program product of claim 30, wherein initiating the interaction with the first user comprises calling the user using one of a telephone connection, a VoIP connection, a video chat connection, and a combination thereof.

32. The computer program product of claim 30, wherein initiating the interaction between the first user and the media program comprises awarding the first user a prize from the media program.

33. The computer program product of claim 30, further comprising instructions operable to cause the computer to:
receive a further use indication each time a further user logs into the application on a further computing device, the further use indication comprising the respective location of the further user;
display the first graphic and the further graphic on the dynamic map.
